(19) United States
(12) Patent Application Publication
(10) Pub. No.: US 2018/0130464 A1
(43) Pub. Date: May 10, 2018

(54) USER INTERFACE BASED VOICE OPERATIONS FRAMEWORK

(71) Applicant: SAP SE, Walldorf (DE)

(72) Inventors: Tal Haviv, Ra'anana (IL); Saar Dagan, Ra'anana (IL); Lior Lavi, Ra'anana (IL)

(21) Appl. No.: 15/345,828

(22) Filed: Nov. 8, 2016

(51) Int. Cl. G10L 15/22; G10L 15/26; G10L 15/00

(52) U.S. Cl. CPC G10L 15/22; G10L 15/26; G10L 2015/221; G10L 2015/223; G10L 15/005

(57) ABSTRACT

A voice command is received in a web application integrated with a voice operations framework. The voice operations framework is integrated as a plugin in the web application. Custom commands are stored in commands storage associated with a UI based voice recognition component. Based on a language set in the web application, automatically set the corresponding language in the voice operations framework. The received voice command is converted into text based on the UI based voice recognition component. Based on the converted text, identify a corresponding UI element command. Based on the UI element command, an actionable UI element is determined. The actionable UI element is executed to perform operations corresponding to the voice command. Based on the determined actionable UI element, text associated with the execution of the actionable UI element is converted to audio in a voice feedback component. The audio is provided as the voice feedback.

### FIELD

Illustrated embodiments generally relate to data processing, and more particularly to frameworks for user interface based voice operations.

### BACKGROUND

In an enterprise application, certain set of users such as industrial machine operators, physically challenged users, etc., may not be in close proximity or may not be able to access hardware devices such as mouse, track pad, keyboard, etc., associated with an enterprise application. When the set of users are not able to or not in a position to access a hardware device, it is difficult to manage and control the enterprise application. Managing and controlling the enterprise application using an alternate mechanism such as voice-enabled commands eliminates accessing the physical hardware device. Integrating voice-enabled mechanism to individual functionalities in the enterprise application is challenging since coding effort is relatively high for integrating voice-enabled mechanism to individual functionalities in the enterprise application.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1 is a block diagram illustrating high-level architecture of user interface based voice operations framework in an application framework, according to one embodiment.

FIG. 2A-FIG. 2C are block diagrams that in combination illustrate user interface for launching and accessing a web application using voice operations framework, according to one embodiment.

FIG. 3 is a block diagram illustrating architecture of voice operations framework, according to one embodiment.

FIG. 4 is a flow chart illustrating a process of user interface based voice operations framework, according to one embodiment.

FIG. 5 is a block diagram illustrating an exemplary computer system, according to one embodiment.

### DETAILED DESCRIPTION

Embodiments of techniques for user interface based voice operations framework are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

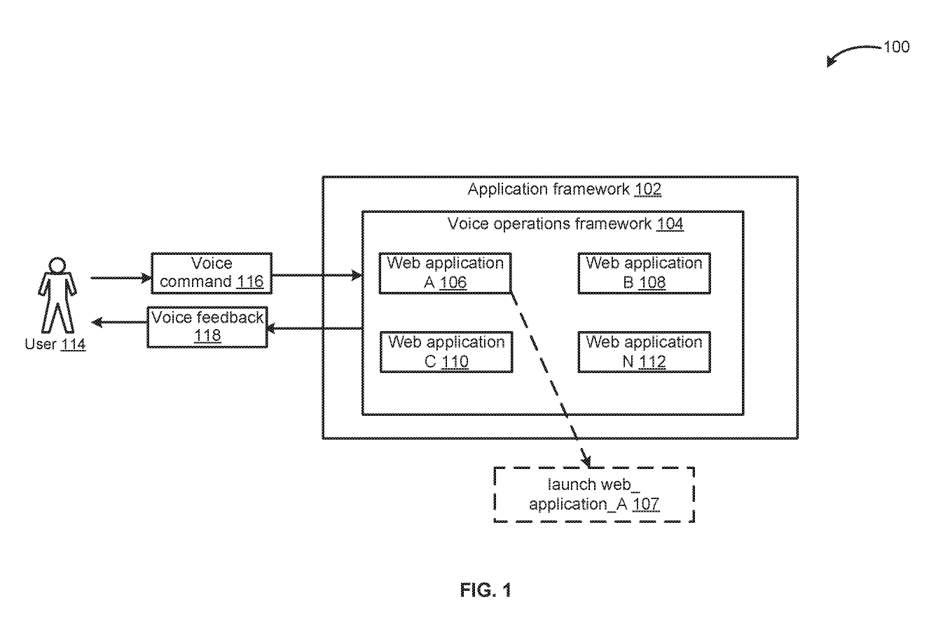

FIG. 1 is block diagram 100 illustrating high-level architecture of user interface based voice operations framework in an application framework, according to one embodiment. An enterprise may have application framework 102 that is a software library providing fundamental structure to support the development of applications for a specific environment. The application framework 102 enables customization of existing applications or building applications from scratch. Program code may be shared across various applications in the application framework 102. The application framework 102 may be used for graphical user interface (GUI) development, and for the web-based application development. Voice operations framework 104 is injected in the application framework 102. Injection may be in the form of application integration, or in the form of a plug-in or pluggable dynamic application. Injection may be in the form of an integrated application development, where software program corresponding to voice operations framework 104 is integrated with software program corresponding to application framework 102. Injection may also be in the form of a pluggable dynamic application, where software program corresponding to voice operations framework 104 is plugged into software program corresponding to application framework 102.

The application framework 102 may include various web applications such as web application A 106, web application B 108, web application C 110 and web application N 112. Since the voice operations framework 104 is injected in the application framework 102, the web applications in the application framework 102 also support the functionalities provided by the voice operations framework 104. Web application A 106, web application B 108, web application C 110 and web application N 112, may be any enterprise web application supporting voice operations framework 104. The web applications may be rendered and executed in various web browsers. The application framework 102, the voice operations framework 104 and the web applications may support operating systems from various vendors and platforms such as Android®, iOS®, Microsoft Windows®, BlackBerry®, etc., and may also support various client devices such as mobile phones, electronic tablets, portable computers, desktop computers, industrial appliances, medical devices, etc.

When a request to launch web application A 106 is received from user 114 as voice command 116, e.g., “launch web application A”, the voice command 116 is received at the voice operations framework 104. The voice operations framework 104 recognizes the voice command 116, and identifies the user interface (UI) element command associated with the UI element web application A 106 button to execute. UI element i.e., web application A 106 is in the form of a button. UI element may be one of the various graphical user interface elements such as menus, icons, widgets, interaction elements, etc., displayed in a user interface. Menus may include various types of menus such as static menus, context menus, menu bar, etc. Widgets may include various types of widgets such as list, buttons, scrollbars, labels, checkboxes, radio buttons, etc. Interaction elements may include various types of interaction elements such as selection, etc. UI element command corresponding to the UI element is identified and executed. UI element command may be an instruction or set of instruction(s) or function calls in a programming language to perform a specific task. For example, for the UI element web application A 106 button, UI element command may be identified as “launch web_application_A” 107. The UI element command “launch web_application_A” 107 enables launching web application A 106 by automatically clicking the UI element web application A 106 button.

The voice operations framework 104 recognizes the voice command 116 “launch web application A”, and executes the UI element command “launch web_application_A” 107 to launch the web application A 106. Voice feedback 118 “launching web application A” is provided to the user 114, before launching the web application A 106. After providing the voice feedback 118, the web application A 106 is launched as a result of execution of the UI element command. In one embodiment, the voice feedback 118 is provided in parallel while launching the web application A 106. Launching web application A 106 is merely exemplary, sequence of operations in the web application A 106 may be performed using voice commands. Voice commands may be queued and executed in a sequence. Based on the voice commands, various operations such as clicking, selecting, deselecting, submitting, highlighting, hovering, launching, etc., can be performed. In one embodiment, the voice operations framework 104 may be injected in one or more of the web applications in the application framework 102. For example, when the voice operations framework 104 is injected in web application A 106, the functionalities of the voice operations framework 104 are available in the web application A 106. Similarly, when the voice operations framework 104 is injected in web application A 106 and web application N 112, the functionalities of the voice operations framework 104 are available in the web application A 106 and the web application N 112.

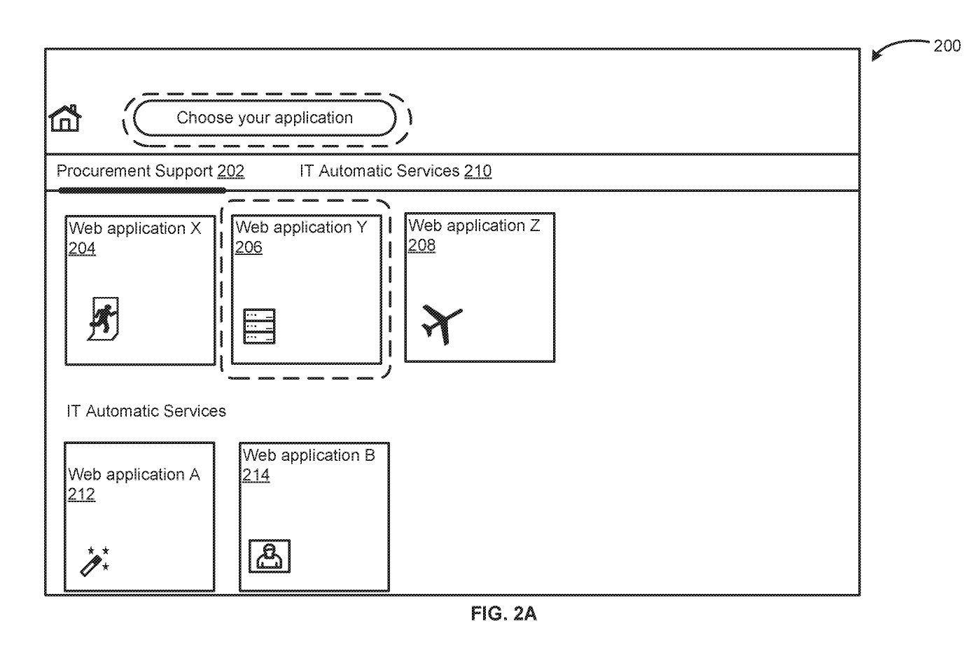

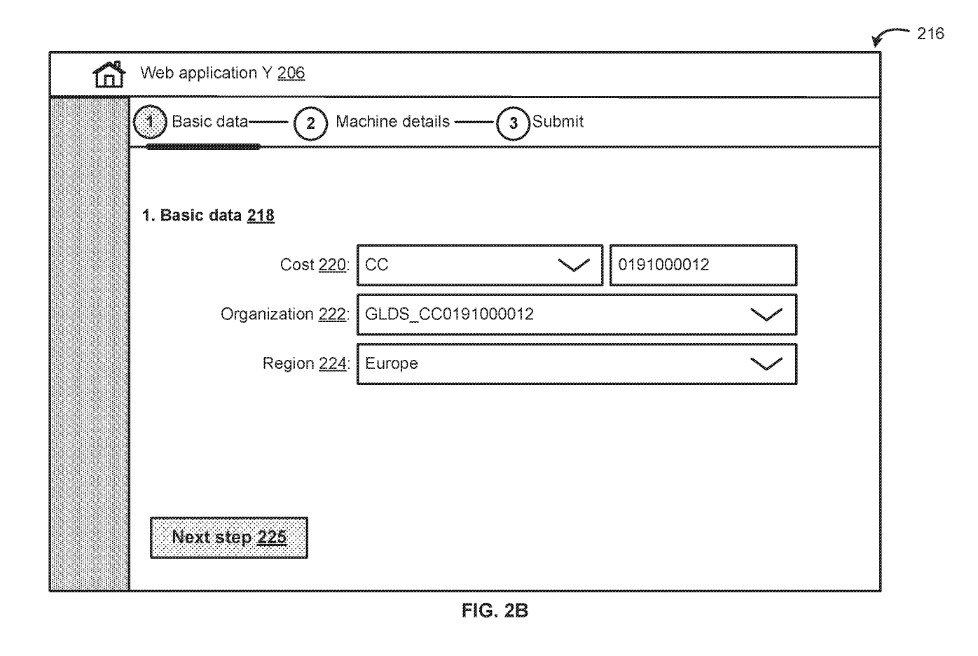

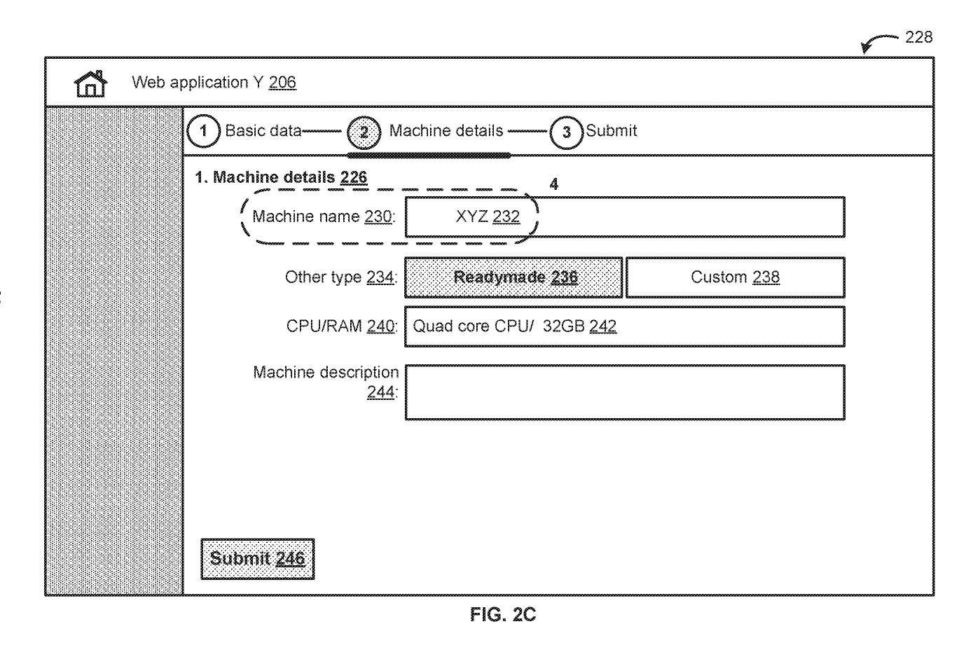

FIG. 2A-FIG. 2C are block diagrams that in combination illustrate user interface for launching and accessing a web application using voice operations framework, according to one embodiment. FIG. 2A is user interface 200 illustrating launching a web application using voice operations framework, according to one embodiment. For example, enterprise application framework for procurement support 202 is launched in a web browser. The enterprise application framework for procurement support 202 is injected with voice operations framework to support the web applications such as web application X 204, web application Y 206, web application Z 208, etc. Enterprise application framework for IT automatic services 210 supporting web application A 212 and web application B 214 is also shown in the user interface 200. User may request launching web application Y 206 using a voice command. A voice command “launch web application Y” is received from the user. The voice operations framework (not illustrated) recognizes the voice command and a corresponding UI element command. The identified UI element command is executed, and a voice feedback “launching web application Y” is provided to the user. The web application Y 206 is launched as shown in FIG. 2B.

FIG. 2B is user interface 216 illustrating display of basic data in the launched web application Y 206, according to one embodiment. In the launched web application Y 206, basic data 218 such as cost 220, organization 222, and region 224 is displayed with corresponding data. A voice command “next step” is received from the user. The voice operations framework recognizes the voice command, and a corresponding UI element command is identified. The identified UI element command is executed, and a voice feedback “launching next step” is provided to the user. The method associated with the button next step 225 is executed, and machine details 226 screen is displayed in user interface 228 as shown in FIG. 2C. In the screen, machine details 226, a user input “set machine name to XYZ” is received as a voice command, and a corresponding UI element command is identified. The identified UI element command is executed, and a voice feedback “setting machine name to XYZ” is provided to the user. The machine name 230 is set to XYZ 232. In the machine details screen 226, order type 234 has two options readymade 236 and custom 238. User may request for help in understanding the options in order type 234. A user request “what is readymade?” is received as voice command, and a corresponding UI element command is identified. The identified UI element command is executed, and a voice feedback “In readymade option, pre-configured quad core CPU and 32 GB random access memory (RAM) is selected” is provided to the user. When a request “select readymade” is received as a voice command, a corresponding UI element command is identified. The identified UI element command is executed, and a voice feedback “setting order type readymade” is provided to the user. The order type is set to readymade 236, and CPU/RAM 240 is populated with data quad core CPU/32 GB as shown in 242. Description of the machine may be provided in machine description 244. When a request “submit” is received as a voice command, a corresponding UI element command is identified. The identified UI element command is executed, and a voice feedback “submitting machine details for procurement” is provided to the user. The corresponding UI element command executes the method associated with button submit 246 in the web application Y 206.

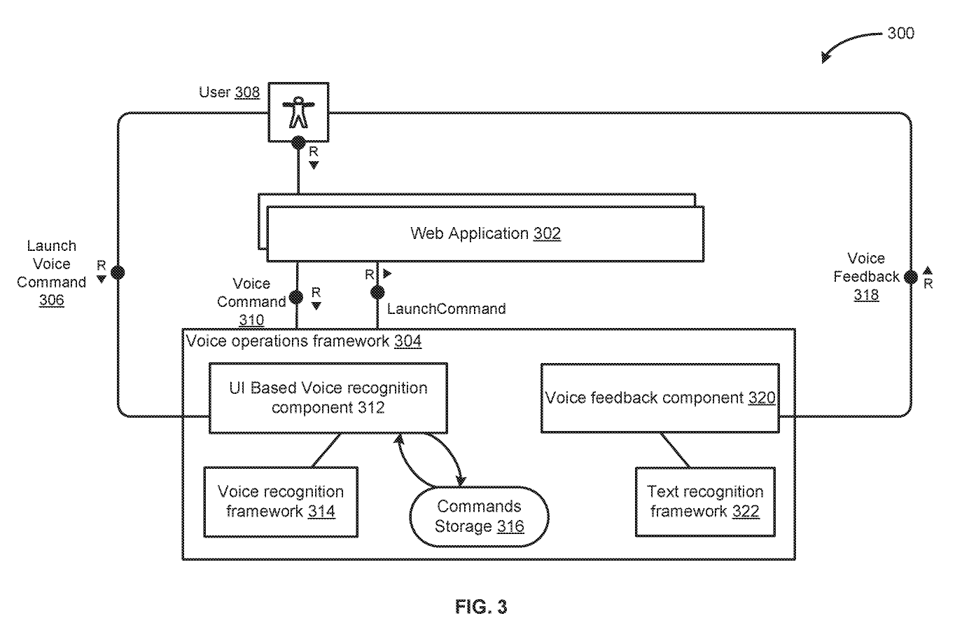

FIG. 3 is a block diagram illustrating architecture 300 of voice operations framework, according to one embodiment. Web application 302 is integrated with voice operations framework 304, to receive voice commands, and perform corresponding operations in the web application 302. When a request to launch voice command 306 is received from user 308, the web application 302 is enabled to receive voice commands. Alternatively, if the voice command is previously enabled, the voice operations framework 304 listens to voice commands instantly when the web application 302 is launched. For example, voice operations framework 304 may be in a programming language such as JavaScript®. JavaScript® is a cross-platform script library designed to simplify client side scripting. The web application 302 may use web documents or web pages that are in Java script and hypertext markup language (HTML). The web application 302 may be rendered and executed in a web browser. The web browser supports launching and executing JavaScript®. HTML document object model (DOM) defines the HTML elements in the web pages as objects, methods to access the objects and events for the objects. With the HTML DOM, JavaScript® can access and change the elements of the web documents or web pages in the web application 302.

A request to access the web application 302 is received from user 308 in the form of voice command 310. The voice command 310 is received by voice operations framework 304. For example, the voice command 310 may be “launch my task window”. The voice operations framework 304 has a UI based voice recognition component 312 that interacts with voice recognition framework 314, and commands storage 316. Voice recognition framework 314, may be any speech recognition or voice recognition application programming interface (API), speech recognition enterprise application, etc. Voice recognition API's may enable conversion of audio to text based on artificial neural networks. Voice recognition API's may recognize various languages, dialects, accents, etc. Language of the web application 302 may be set based on the locale. Language supported by the voice operations framework 304 depends on the language set in the web application 302. When the language of the web application 302 is changed to a different language, the voice operations framework may dynamically support the different language recently changed. The voice command 310 is received by the UI based voice recognition component 312 in the voice operations framework 304.

Voice recognition framework 314 may recognize a standard set of commands. Custom commands are stored in command storage 316 in the voice operations framework 304. Voice recognition framework 314 may be a speech to text API that includes pre-defined programs or routines to receive voice commands, and convert the voice commands to text. The voice command 310, e.g. “launch my task window”, is converted to text “launch my task window” using the voice recognition framework 314. Based on the converted text, corresponding UI element command “launch my_task” is identified from the custom commands in the commands storage 316. Based on the identified UI element command “launch my_task”, the voice operations framework 304, searches the HTML DOM for actionable UI element. Actions such as function and/or software program routine associated with the UI element are specified in the actionable UI element. When the actionable UI element e.g. “onclick=mytask( )” is identified, the actionable UI element is executed or triggered. Triggering or executing the actionable UI element “onclick=mytask( )” may be performed through event handler such as onclick event handler. Triggering “onclick” event may be performed using JQuery trigger( ) method. The trigger( ) method triggers the specified event and launches my task window. Just before launching the my task window, voice feedback 318 “launching my task window” may be provided to the user 308. The voice feedback 318 is provided by the voice feedback component 320. UI based voice recognition component 312 and the voice feedback component 320 may be developed in any programming language. Voice feedback component 320 may convert text to audio just before triggering the “onclick” event. Voice feedback component 320 can be configured to convert text to audio on the actionable UI element being interacted with. The converted audio “launching my task window” is provided to the user 308 as voice feedback 318. Voice feedback component 320 may use text recognition framework 322 to convert text to audio corresponding to the language set in the web application 302. Text recognition framework 322 may be a text to speech API that includes pre-defined programs or routines to receive text, and convert the text to audio. The converted audio is provided to the user 308 through an audio speaker.

The voice operations framework 304 recognizes audible voice commands. The voice operations framework 304 does not recognize background noise, and voice that is not audible. When the voice operations framework 304 does not recognize the voice command, no operation is performed on the web application 302. When more than one voice command is received in the web application 302, the voice commands are queued, and executed in a sequence one after the other. In one embodiment, the voice operations framework 304 can be dynamically plugged into different web applications, and such web applications may be developed using different software programming languages. A web application may be an enterprise web application supporting complex functionalities. The web application may be an independent enterprise web application, or a module/sub-application in the enterprise web application. Based on the voice commands, various types of operations can be performed on the web application 302. The voice operations framework 304, can support various web browsers such as Firefox®, Internet Explorer®. Google Chrome®, Opera®, Safari®, etc. The voice operations framework 304, can support various operating systems from various vendors and platforms such as Android®, iOS®, Microsoft Windows®, BlackBerry®, etc. Since the voice operations framework 304 can be plugged into different web applications dynamically, software code corresponding to the voice operations framework 304 is reused for individual web applications, and repeated development effort for every web application is avoided.

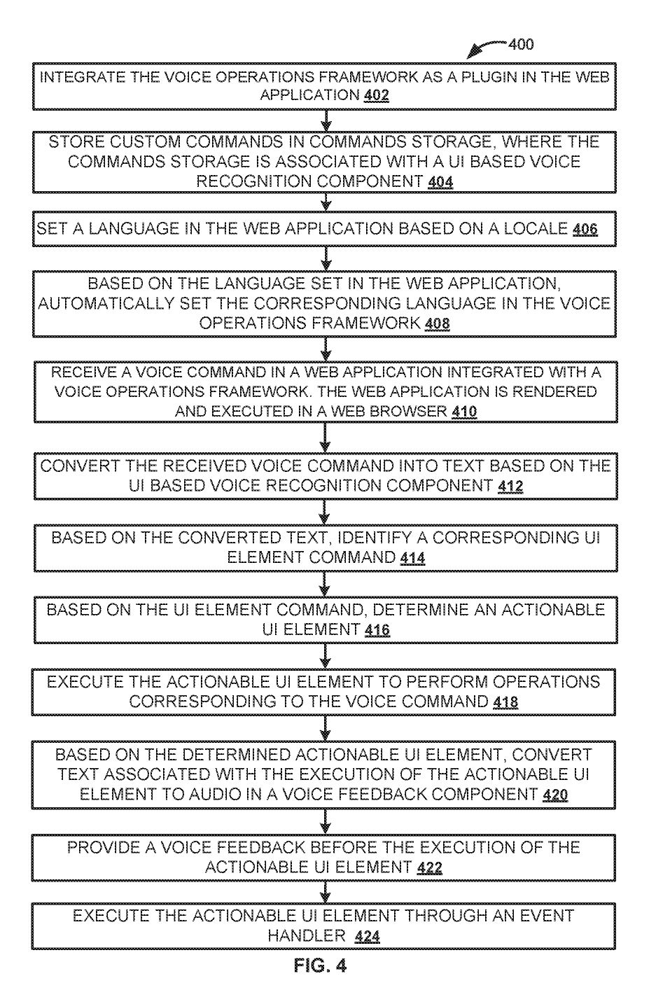

FIG. 4 is a flow chart 400, illustrating a process of user interface based voice operations framework, according to one embodiment. At 402, the voice operations framework is integrated as a plugin in the web application. At 404, custom commands are stored in commands storage. The commands storage is associated with a UT based voice recognition component. At 406, a language is set in the web application based on a locale. At 408, based on the language set in the web application, automatically set the corresponding language in the voice operations framework. At 410, a voice command is received in a web application integrated with a voice operations framework. The web application is rendered and executed in a web browser. At 412, the received voice command is converted into text based on the UI based voice recognition component. At 414, based on the converted text, identify a corresponding UI element command. At 416, based on the UI element command, an actionable UI element is determined. At 418, the actionable UI element is executed to perform operations corresponding to the voice command. At 420, based on the determined actionable UI element, text associated with the execution of the actionable UI element is converted to audio in a voice feedback component. At 422, a voice feedback is provided before the execution of the actionable UI element. At 424, the actionable UI element is executed through an event handler.

Some embodiments may include the above-described methods being written as one or more software components. These components, and the functionality associated with each, may be used by client, server, distributed, or peer computer systems. These components may be written in a computer language corresponding to one or more programming languages such as functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media, and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java. C++, or other object-oriented programming language and development tools. Another embodiment may be implemented in hard-wired circuitry in place of, or in combination with machine readable software instructions.

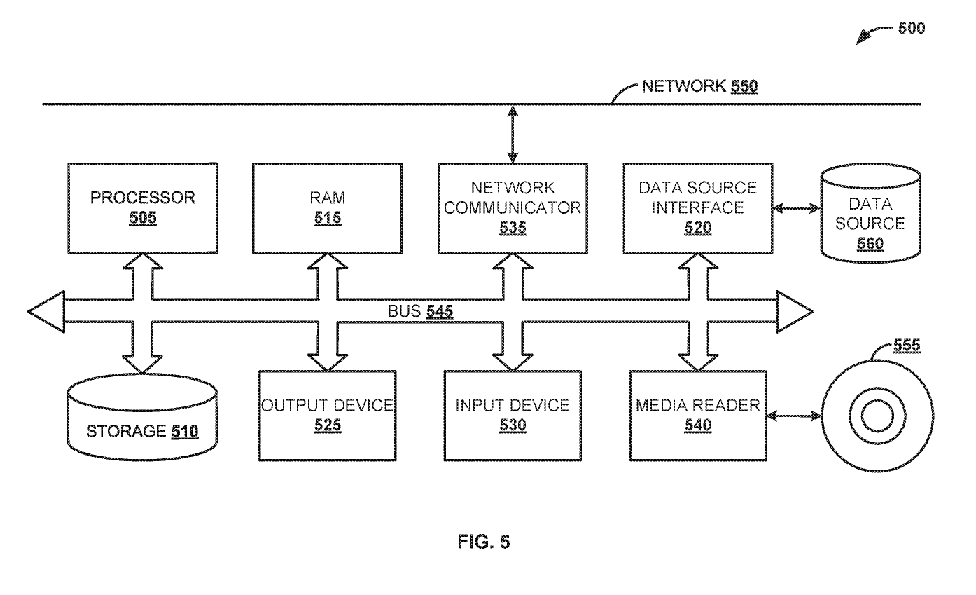

FIG. 5 is a block diagram of an exemplary computer system 500. The computer system 500 includes a processor 505 that executes software instructions or code stored on a computer readable storage medium 555 to perform the above-illustrated methods. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as a semantic layer.

A data source is an information resource. Data sources include sources of data that enable data storage and retrieval. Data sources may include databases, such as relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

1. A non-transitory computer-readable medium to store instructions, which when executed by a computer, cause the computer to perform operations comprising:
receive a voice command in a web application integrated with a voice operations framework, wherein the web application is rendered and executed in a web browser in a graphical user interface and the voice operations framework is injected in the form of a pluggable dynamic application into the web application;
convert the received voice command into text based on a UI based voice recognition component;
based on the converted text, identify a corresponding UI element command from a hypertext markup language (HTML) document object model (DOM) associated with the web application;
based on the UI element command, determine an actionable UI element; and
execute the actionable UI element to perform operations corresponding to the voice command.

2. The computer-readable medium of claim 1, further comprises instructions which when executed by the computer further cause the computer to:
based on the determined actionable UI element, convert text associated with the execution of the actionable UI element to audio in a voice feedback component; and
provide a voice feedback before the execution of the actionable UI element.

3. The computer-readable medium of claim 1, further comprises instructions which when executed by the computer further cause the computer to:
store custom commands in a commands storage associated with the UI based voice recognition component.

4. The computer-readable medium of claim 1, wherein the voice commands are queued and executed in a sequence.

5. The computer-readable medium of claim 1, further comprises instructions which when executed by the computer further cause the computer to:
set a language in the web application based on a locale; and
based on the language set in the web application, automatically set the corresponding language in the voice operations framework.

6. The computer-readable medium of claim 1, wherein executing the actionable UI element, further comprises instructions which when executed by the computer further cause the computer to:
execute the actionable UI element through an event handler; and
trigger the event handler is performed using a cross-platform script library.

7. A computer-implemented method of user interface based voice operations framework, the method comprising:
receiving a voice command in a web application integrated with a voice operations framework, wherein the web application is rendered and executed in a web browser and the voice operations framework is injected in the form of a pluggable dynamic application into the web application;
converting the received voice command into text based on a UI based voice recognition component;
based on the converted text, identifying a corresponding UI element command from a hypertext markup language (HTML) document object model (DOM) associated with the web application;
based on the UI element command, determining an actionable UI element; and
executing the actionable UI element to perform operations corresponding to the voice command.

8. The method of claim 7, further comprising:
based on the determined actionable UI element, converting text associated with the execution of the actionable UI element to audio in a voice feedback component; and
providing a voice feedback before the execution of the actionable UI element.

9. The method of claim 7, further comprising:
storing custom commands in a commands storage associated with the UI based voice recognition component.

10. The method of claim 7, wherein the voice commands are queued and executed in a sequence.

11. The method of claim 7, further comprising:
setting a language in the web application based on a locale; and
based on the language set in the web application, automatically setting the corresponding language in the voice operations framework.

12. The method of claim 7, wherein executing the actionable UI element, further comprising:
executing the actionable UI element through an event handler; and
triggering the event handler is performed using a cross-platform script library.

13. A computer system for user interface based voice operations framework, comprising:
a computer memory to store program code; and
a processor to execute the program code to:
receive a voice command in a web application integrated with a voice operations framework, wherein the web application is rendered and executed in a web browser and the voice operations framework is injected in the form of a pluggable dynamic application into the web application;
convert the received voice command into text based on a UI based voice recognition component;
based on the converted text, identify a corresponding UI element command from a hypertext markup language (HTML) document object model (DOM) associated with the web application;
based on the UI element command, determine an actionable UI element; and
execute the actionable UI element to perform operations corresponding to the voice command.

14. The system of claim 13, wherein the processor further executes the program code to:
based on the determined actionable UI element, convert text associated with the execution of the actionable UI element to audio in a voice feedback component; and
provide a voice feedback before the execution of the actionable UI element.

15. The system of claim 13, wherein the processor further executes the program code to:
store custom commands in a commands storage associated with the UI based voice recognition component.

16. The system of claim 13, wherein the voice commands are queued and executed in a sequence.

17. The system of claim 13, wherein the processor further executes the program code to:
set a language in the web application based on a locale; and
based on the language set in the web application, automatically set the corresponding language in the voice operations framework.

18. The system of claim 13, wherein generating executing the actionable UI element further executes the program code to:
execute the actionable UI element through an event handler; and
triggering the event handler is performed using a cross-platform script library.
